(19) United States
(12) Patent Application Publication
(10) Pub. No.: US 2010/0073626 A1
(43) Pub. Date: Mar. 25, 2010

(54) Folding glasses and enclosure with light source

(76) Inventor: John A. Engstrom, Santa Ana, CA (US)

Correspondence Address: Morland C. Fischer;Suite 1300, 2030 Main Street, Irvine, CA, 92614, US

(21) Appl. No.: 12/383,246

(22) Filed: Mar. 23, 2009

Related U.S. Application Data
(63) Continuation-in-part of application No. 12/284,730, filed on Sep. 25, 2008.

(51) Int. Cl. G02C 11/04; G02C 11/00

(52) U.S. Cl. 351/63; 351/158

(57) ABSTRACT

Folding glasses of the kind to be worn for reading or magnifying images and including a pair of lenses to be positioned over the eyes of a user or in front of material to be enlarged. The folding glasses have first and second rims surrounding respective ones of the lenses. The first and second rims are pivotally connected together such that the first lens is rotatable relative to the second lens so as to lie in opposite facing alignment with the second lens. The rim surrounding the second lens is pivotally connected to an enclosure so that the first and second lenses lying one above the other are rotatable in a compact, space-efficient folded configuration for receipt inside the enclosure so as to be conveniently transported therewithin. A light source is mounted on the enclosure, and a battery is carried by the enclosure. The battery is electrically connected to the light source by the user in order to provide power to the light source and thereby cause an illumination thereof.

### CROSS-REFERENCE TO RELATED APPLICATION

This application is a continuation-in-part of application Ser. No. 12/284,730 filed Sep. 25, 2008.

### BACKGROUND OF THE INVENTION

1. Field of the Invention

Folding glasses are disclosed of the type to be used from time-to-time for reading or magnifying images. A pivotal connection extends between a pair of optical or magnifying lenses to permit the glasses to be manipulated to a space-efficient folded configuration at which to be removably received for storage and transport within a compact enclosure.

2. Background Art

Depending upon his circumstances, a wearer may need to have available a pair of glasses to be worn from time-to-time for reading when his existing eyesight or a primary pair of distance glasses is ineffective. That is to say, the wearer will be required to carry with him or have ready access to a pair of reading glasses that will only be worn on a short-time basis. Sometimes, because of its size, there is no place on the wearer's person at which to easily carry a pair of reading glasses. Other times, the wearer may simply forget to carry his reading glasses. Consequently, the wearer will be deprived of the benefit of having with him on a regular basis a pair of glasses to be worn on those occasions when small print must be read.

Therefore, what is desirable is a pair of (e.g., reading or magnifying) glasses that can be folded in a space-efficient configuration for receipt within a compact enclosure that is suitable to be conveniently and non-obtrusively carried on a regular basis in the wearer's shirt pocket, pants pocket, purse, key chain, and the like.

### SUMMARY OF THE INVENTION

Folding glasses are disclosed according to a first preferred embodiment of this invention having particular application for reading. The folding glasses include a pair of optical lenses, a first frame end surrounding at least some of a first of the pair of lenses, and a second frame end surrounding at least some of the other lens. A flexible bridge extends between the first and second frame ends. By virtue of the flexible bridge, the frame ends can be manipulated from an unfolded configuration, at which the pair of lenses are axially-aligned with one another to cover the eyes of a wearer, to a folded configuration, at which the first and second frame ends are rotated towards one another so that the pair of lenses are positioned one above the other. By way of example only, the flexible bridge extending between the first and second frame ends has a spring memory. In this case, the flexible bridge may be one of a wire manufactured from spring steel or a coil spring that is bent (i.e., stressed) when the frame ends are rotated to the folded configuration. By way of an additional example, the flexible bridge includes a hinge around which the frame ends are rotated to the folded configuration.

With the first and second frame ends rotated to the folded configuration, the glasses will be sized to fit and be transported within a compact enclosure. The enclosure allows the folded glasses to be conveniently and non-obtrusively carried on a regular basis in the wearer's shirt pocket, pants pocket, purse, and the like. A ring attached to the enclosure facilitates coupling the enclosure to a key chain or a key ring. In this manner, the glasses will be carried along with the wearer's keys so as not to be easily forgotten and left behind.

Folding glasses are disclosed according to a second preferred embodiment of this invention having particular application for magnifying or enlarging images. The folding glasses include a pair of (e.g., plastic) magnifying lenses and a pair of rims surrounding respective ones of the lenses. The first and second rims are pivotally connected together so that the first lens is rotated relative to the second lens to a folded configuration of the folding glasses so as to lie in opposite facing alignment with the second lens. The rim surrounding the second lens is pivotally connected to an enclosure so that the first and second lenses lying one above the other in the folded configuration can be rotated from a position outside the enclosure to a position inside the enclosure so as to be transported therewithin. The enclosure carries an (e.g., LED) light source and a battery. The battery is electrically connected to the light source to provide power thereto when the battery and the light source are pushed into direct contact with one another or when an electrical switch connected between the light source and the battery is moved to a closed switch position.

### BRIEF DESCRIPTION OF THE DRAWINGS

FIG. 1 shows folding glasses according to a preferred embodiment of this invention disposed in a folded configuration and located within a compact enclosure;

FIG. 2 shows the folding glasses being removed from the compact enclosure of FIG. 1 in the folded configuration;

FIG. 3 shows the folding glasses in an unfolded configuration ready to wear;

FIG. 4 shows details of one example of a flexible bridge located between first and second frame ends of the folding glasses;

FIG. 5 shows details of another example of a flexible bridge located between the first and second frame ends of the folding glasses;

FIG. 6 shows the folding glasses disposed in a folded configuration for removable receipt within a key case;

FIGS. 7 and 8 show folding glasses according to another preferred embodiment of this invention after being rotated to a folded configuration and then being rotated within a compact enclosure;

FIG. 9 shows the folding glasses of FIGS. 7 and 8 in the folded configuration after being rotated outside the enclosure;

FIG. 10 shows the folding glasses outside the enclosure in an unfolded configuration;

FIG. 11 shows the compact enclosure having a light source mounted thereon; and

FIG. 12A-12D illustrate details of the light source being moved into electrical contact with a battery carried by the enclosure to power the light source.

### DESCRIPTION OF THE PREFERRED EMBODIMENT

Folding glasses 1 according to a preferred embodiment of this invention are initially described while referring to FIGS. 1-3 of the drawings. The folding glasses 1 illustrated in the drawings are typically those such as reading glasses of the kind that are required from time-to-time for reading small print. However, it is to be understood that the improvement described herein is not limited to any particular type of glasses and is applicable to other types, such as sun-blocking glasses, distance glasses, and the like.

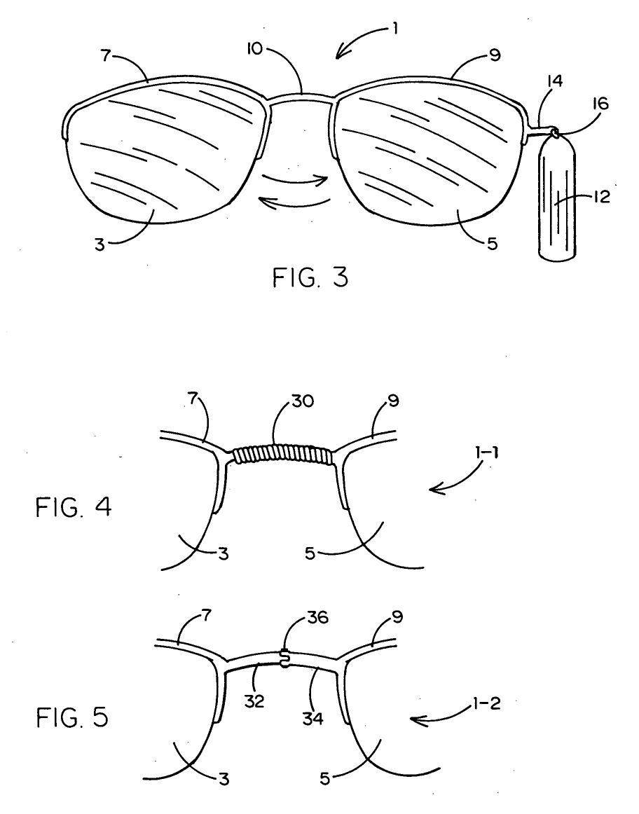

As is best shown in FIG. 3, the folding glasses 1 herein disclosed include a pair of optical lenses 3 and 5 that are spaced axially from one another and surrounded by respective frame ends 7 and 9. A bridge 10 is connected between the frame ends 7 and 9 so that a continuous support is provided for the pair of lenses 3 and 5. As in conventional glasses, the opposing frame ends 7 and 9 and the bridge 10 extending therebetween are sized and shaped to be seated upon the nose of the wearer so that the lenses 3 and 5 of the folding glasses 1 will be positioned over the wearer's eyes.

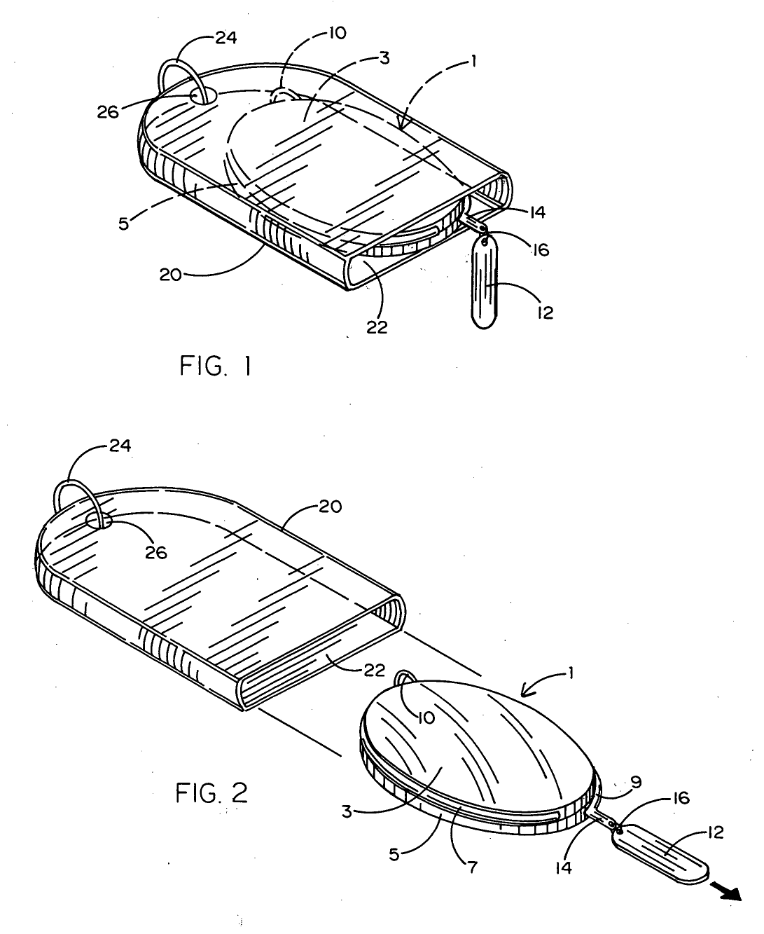

However, unlike conventional glasses, the folding glasses 1 are devoid of the usual arms that are pivotally coupled to the frame ends 7 and 9 to rest upon respective ones of the wearer's ears. By avoiding the arms, and as will soon be explained, the folding glasses 1 may be more easily stored and transported in a space efficient folded configuration within a compact enclosure (designated 20 in FIGS. 1 and 2). In place of the traditional arms, the folding glasses 1 include a short handle 12 by which to enable the wearer to easily manipulate the glasses into and out of the aforementioned enclosure 20. The handle 12 is attached to one of the frame ends (e.g., 9) by means of a relatively short (e.g., 5 mm) frame extension 14. The handle 12 can be fixedly connected to the frame extension 14 or, in the alternative, pivotally connected thereto by means of a suitable fastener (e.g., a rivet) 16. In this case, the handle 12 will be rotatable relative to the lenses 3 and 5 to enable the wearer to either remove the folding glasses 1 from the enclosure 20 and/or hold the glasses upon his nose for occasional use depending upon the optical characteristics of lenses 3 and 5 and the needs of the wearer.

In accordance with an important feature of this invention, the opposing frame ends 7 and 9 are capable of being folded towards one another to establish the aforementioned space-efficient configuration suitable for storage and transport within the enclosure 20 when use of the lenses 3 and 5 is not required. The foregoing folding capability is achieved by the bridge 10 between frame ends 7 and 9 having a flexible characteristic. By way of a first example, and continuing to refer to FIGS. 1-3, the flexible bridge 10 between frame ends 7 and 8 is a wire that is manufactured from spring steel so as to have a spring memory. In this case, the frame ends 7 and 9 of folding glasses 1 are preferably manufactured from metal or a metal allow to enable the flexible wire bridge 10 to be reliably connected therebetween.

By virtue of its flexible nature, the wire bridge 10 will be stressed and bent by the wearer when the opposing frame ends 7 and 9 are rotated downwardly and towards one another (in the direction of the reference arrows of FIG. 3) so that the lens 5 will lie under and against the lens 3 (best shown in FIG. 2). The wearer may then grasp the folded lenses 3 and 5 and apply a pushing force thereto so as to cause his glasses 1, in the space-efficient folded configuration, to slide inwardly of the enclosure 20 (best shown in FIG. 1) for storage and transport.

The enclosure 20 is preferably manufactured from a material (e.g., vinyl or cloth) that will not scratch the lenses 3 and 5 carried therewithin. The enclosure 20 has an open end 22 within which to receive the glasses 1 in the folded configuration in response to a pushing force applied thereto. In this same regard, whenever they are needed, the glasses 1 can be removed from the open end 22 of enclosure 20 in response to a pulling force applied to handle 12 (represented by the reference arrow in FIG. 2). The spring memory of the wire bridge 10 will cause the glasses 1 to automatically expand from the aforementioned folded configuration to their initial unfolded configuration (of FIG. 3) with the lenses 3 and 5 separated from and axially aligned with one another by which to cover the eyes of the wearer.

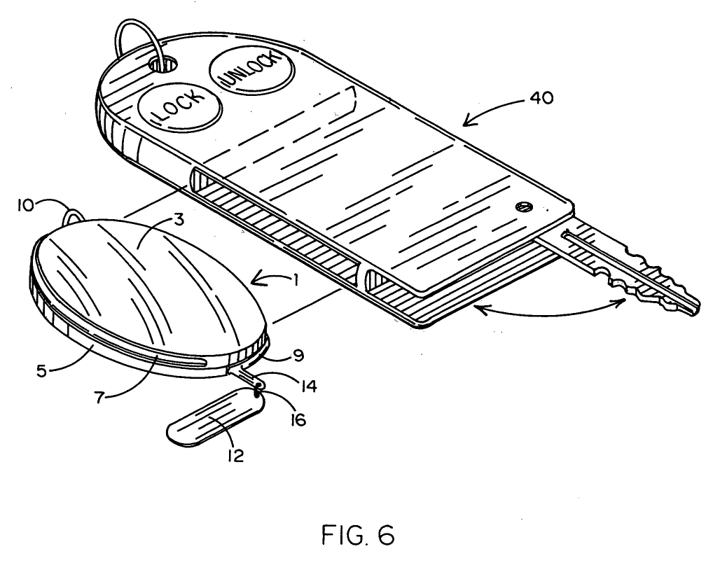

Ideally, the enclosure 20 is a small case or pouch having a flexible characteristic so as to be adapted to expand around and prevent the glasses 1 in the folded configuration from accidentally sliding outwardly through the open end 22. In the alternative, the enclosure 20 may have an inflexible, rigid construction to retain the folded glasses 1 therein by means of friction. By way of example, and as is best shown in FIG. 6 of the drawings, the enclosure may be a molded plastic key case 40 in which the key for operating a motor vehicle is carried. The enclosure 20 holds the glasses 1 in the folded configuration of FIGS. 1 and 2 so as to overcome the normal bias and spring memory of the bent wire bridge 10 to regain its normal unstressed shape and thereby automatically return the folded glasses 1 to their unfolded configuration of FIG. 3. The enclosure 20 allows the glasses 1 in their folded configuration to be conveniently and non-obtrusively carried on a regular basis in the wear's shirt pocket, pants pocket, purse, etc.

A ring 24 is carried by an end of the enclosure 20 that lies opposite the open end 22. The ring 24 is attached to enclosure 20 at a hole 26 formed therethrough. The ring 24 provides the wearer with the advantage of being able to carry small articles (e.g., a key) alongside the enclosure 20. In addition, the ring 24 enables the enclosure 20 to be coupled to a key chain or a key ring. In this manner, the wearer will advantageously be able to carry a pair of reading glasses along with his house keys or car keys such that the glasses will not be easily forgotten and left behind.

Alternative preferred embodiments by which to enable the opposing frame ends 7 and 9 to be rotated to the folded configuration of FIGS. 1 and 2 are now described while referring to FIGS. 4 and 5 of the drawings. In FIG. 4, the bridge extending between the opposing frame ends 7 and 9 of the folding glasses 1-1 is a flexible coil spring 30. Coil spring 30 is preferably manufactured from metal. Like the flexible wire bridge 10 of FIG. 3, the flexible coil spring 30 will be stressed and bent when the opposing frame ends 7 and 9 are rotated downwardly and towards one another so that the lens 5 will lie under and against the lens 3. The glasses 1-1 of FIG. 4 in the folded configuration (not shown) can be slidably received by the previously-described compact enclosures 20 and 40 of FIGS. 1 and 6 for storage and transport. The enclosure 20 or 40 holds the glasses 1 in their folded configuration and overcomes the normal bias and memory of the flexible coil spring 30 to return to its normal unstressed configuration of FIG. 4.

In FIG. 5, the bridge extending between the opposing frame ends 7 and 9 of the folding glasses 1-3 includes a hinge having a pair of interlocking complementary hinge members 32 and 34 that are pivotally coupled together by means of a hinge pin 36. In this case, the interlocking hinge members 32 and 34 and the corresponding frame ends 7 and 9 from which the hinge ends depend are rotatable around the hinge pin 36 to achieve a folded configuration with the lenses 3 and 5 arranged back-to-back one another such that the glasses 1-3 will be sized for slidable receipt by and transport within the compact enclosures 20 and 40 of FIGS. 1 and 6.

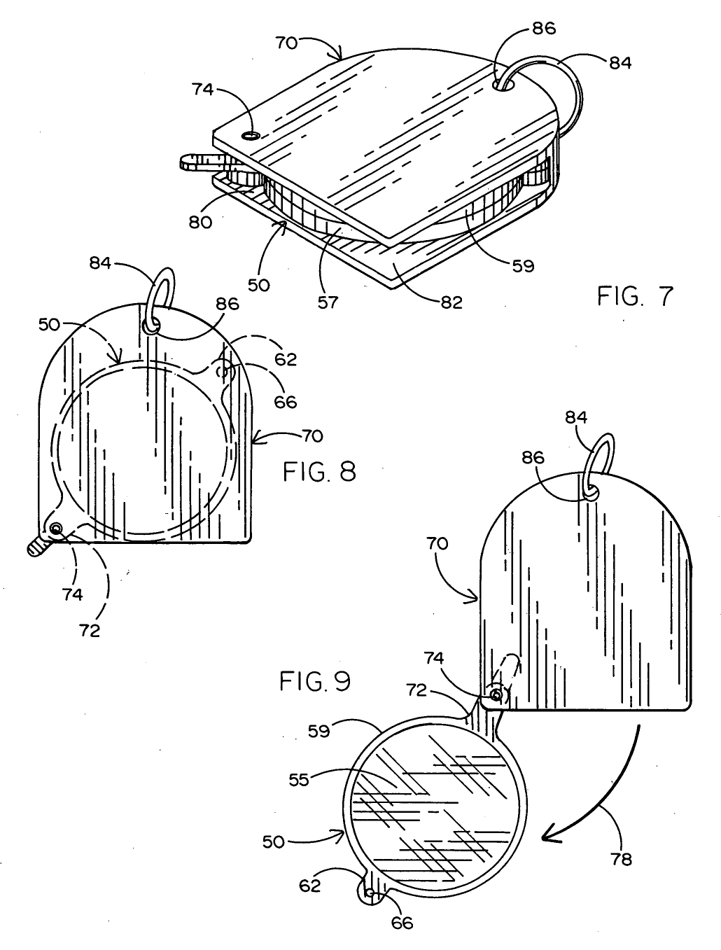

A modification to the folding glasses that are shown in FIGS. 1-6 to facilitate their storage and transport in a non-obtrusive, easy-to-carry enclosure according to another preferred embodiment of this invention is now disclosed while referring to FIGS. 7-10 of the drawings. As earlier described, a pair of frame ends 7 and 9 of folding glasses 1, 1-1 and 1-2 of FIGS. 1-6 are rotated towards one another at a respective wire bridge 10, coil spring 30 or hinge pin 36. However, in some situations, the user may not need or want to spend the cost to obtain glasses having specially-prepared optical lenses 3 and 5 of the kind used for reading. That is to say, where the user is merely seeking to improve his ability to see small text or enlarge figures, simple, inexpensive magnifying lenses (sometimes known as “magnifying glasses”) can be used in substitution of the reading lenses 3 and 5.

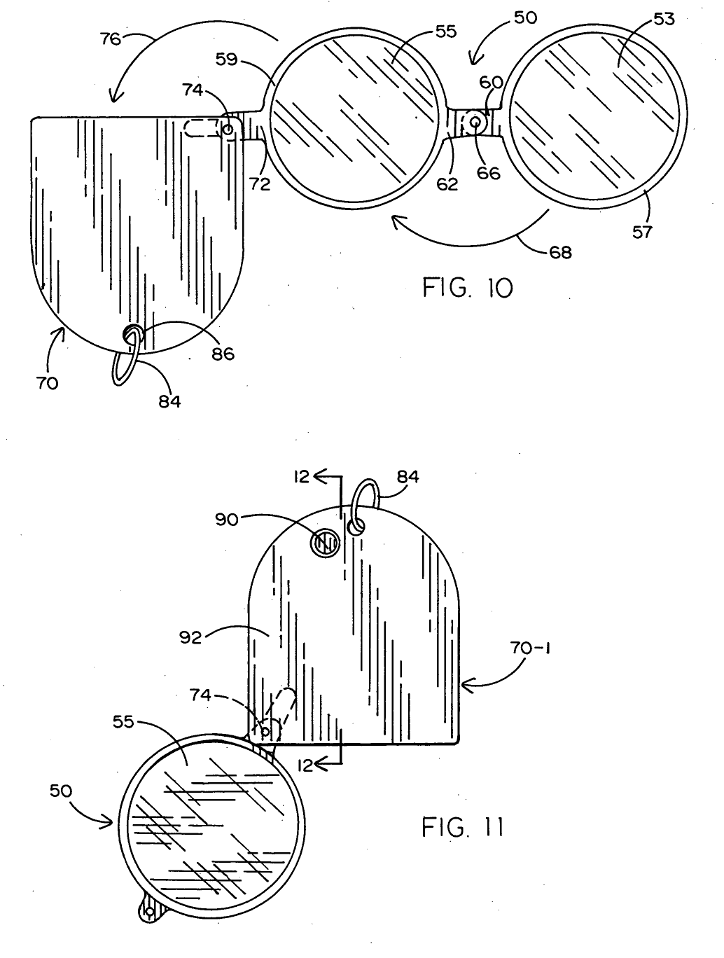

In the example of FIGS. 7-10, folding glasses 50 include a pair of magnifying lenses 53 and 55 (best shown in FIG. 10) that are surrounded by rims 57 and 59. Like the folding glasses earlier disclosed, the folding glasses 50 are devoid of the usual arms that would normally be connected to the rims 57 and 59 to engage the ears of the user. The lenses 53 and 55 as well as the surrounding rims 57 and 59 are ideally manufactured from plastic to minimize the weight and cost of the glasses 50. Projecting towards one another from each of the rims 57 and 59 so as to lie in axial alignment one above the other are coupling tabs 60 and 62. The coupling tabs 60 and 62 are connected together by means of a fastener 66, such as a pivot pin, a rivet, or the like. In this manner, a first of the magnifying lenses (e.g., 53) can be rotated around fastener 66 so as to move towards (in the direction of the reference arrow 68 of FIG. 10) and rest below the other lens 55. Where the magnifying lenses 53 and 55 are substantially flat, the lenses 53 and 55 will lie face-to-face one another, whereby the glasses 50 are folded into a compact, space-efficient configuration for removable receipt by a correspondingly compact enclosure 70.

The rim 59 around the other lens 55 of the pair of magnifying lenses 53 and 55 of folding glasses 50 includes a coupling tab 72 projecting outwardly therefrom for connection to the enclosure 70. Coupling tabs 62 and 72 project outwardly and in opposite direction from the rim 59. The coupling tab 72 is connected to a corner of the enclosure 70 by means of a fastener 74, such as a pivot pin, a rivet or the like. In this manner, after the first lens 53 has been rotated to lie in opposite facing alignment with the second lens 55, the lens 55 can be rotated around fastener 74 so as to move together with the first lens 53 towards (in the direction of the reference arrow 76 of FIG. 10) and into removable receipt by the enclosure 70. FIGS. 7 and 8 show the folding glasses 50 with the magnifying lenses 53 and 55 thereof rotated one above the other and located within the enclosure 70. In this regard, the glasses 50 can be removed (i.e., rotated outwardly) from the enclosure 70 (in the direction of the reference arrow 78 of FIG. 9) and the lenses 53 and 55 rotated apart whenever and wherever their use is required. To facilitate the removal of the glasses 50 from enclosure 70, a short arm 79 projects from one of the frames (e.g., 59) to receive a pulling force applied thereto by the user.

The folding glasses 50 are used in an unfolded configuration following their removal from the enclosure 70 and a rotation of the magnifying lenses 53 and 55 apart from one another in a direction opposite that represented by the reference arrow 68 of FIG. 10. The lenses 53 and 55 may then be held up to the eyes of the user and/or in front of the material of interest to be magnified and more easily read.

The enclosure 70 of FIGS. 7-10 is similar to the flexible enclosure 20 that is shown in FIGS. 1 and 2 of the drawings. However, the enclosure 70 preferably has an open end 80 and an adjacent open side 82 (best shown in FIG. 7) through which the glasses 50 in their folded configuration are received in or removed from enclosure 70 in response to a pushing or pulling force. The enclosure 70 allows the glasses 50 in their folded configuration to be conveniently carried by the user in his shirt pocket, pants pocket, purse, etc. A ring 84 is carried by a closed end of the enclosure 70 which lies opposite the open end 80. The ring 84 is attached to enclosure 70 at a hole 86 formed through the closed end which lies opposite the open end 80. The ring 84 provides the user with the advantage of being able to carry small articles (e.g., keys) alongside the enclosure. In addition, the enclosure 70 can be attached to a key chain or key ring (not shown) by way of the ring 84 so that the glasses 50 cannot be easily misplaced or left behind.

FIG. 11 of the drawings shows a flexible enclosure 70-1 like that illustrated in FIGS. 7-10 with the addition of a light source 90. In certain situations, there may be insufficient light for the user to clearly see the material of interest even after the glasses 50 are rotated to their unfolded configuration to enable such material to be magnified and enlarged. By way of particular example, the light source 90 is a light emitting diode. However, the light source 90 may be any other suitable light-generating means that is adapted to be powered by a DC (i.e., battery) voltage.

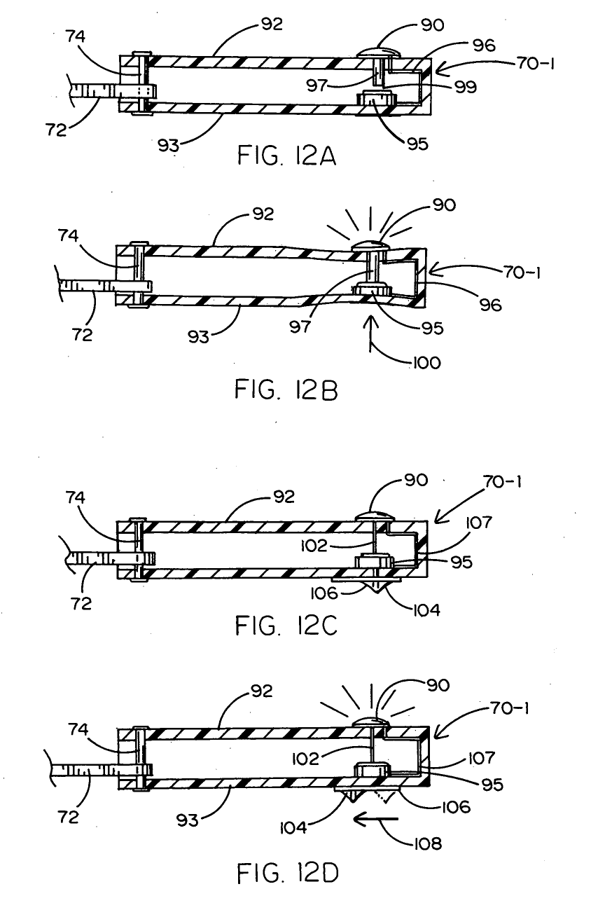

Turning now to FIGS. 12A-12D, the light source 90 is shown mounted on the exterior of one face 92 of the enclosure 70-1. A 1.5 volt watch battery is located inside and affixed below the opposite face 93 of the enclosure 70-1. A thin wire or conductive strip 96 runs along the interior of the enclosure 70-1 between the battery 95 and the light source 90. The light source 90 is axially aligned with and located above the battery 95. As shown in FIGS. 12A and 12B, an electrically-conductive post 97 projects downwardly from the light source 90 so as to extend through the enclosure 70-1 in a direction towards the battery 95. In the relaxed condition of the enclosure 70-1 as shown in FIG. 12A, the conductive post 97 is spaced from the battery 95 such that a small gap 99 separates the post 97 from the battery 95 so as to avoid electrical contact therebetween, whereby the light source 90 is de-energized. It may be appreciated that when the folding glasses 50 are rotated to the folded configuration and pushed inside the enclosure 70-1 (as illustrated in FIG. 7), the thickness of the magnifying lenses will prevent the conductive post 97 from moving through the gap 99 and into electrical contact with the battery 95.

When the folding glasses 50 are rotated at fastener 74 outside the enclosure 70-1, the light source 90 may be selectively energized by the user. As shown in FIG. 12B, a compressive pushing force (represented by reference arrow 100) is applied to the face 93 of enclosure 70-1 to cause the face 93 to move towards the opposing face 92. As the faces 92 and 93 are pushed together, the battery 95 carried inside the face 93 will correspondingly move towards the conductive post 97 projecting from the light source 90. Accordingly, the gap 99 (of FIG. 12A) will be eliminated, and the battery 95 will be moved into electrical contact with the post 97, whereby to complete an electrical circuit to cause the light source 90 to be energized and illuminated. When the pushing force 100 is terminated or when the glasses 50 are returned to the enclosure 70-1, the gap 99 between battery 95 and post 97 will be restored, and the light source 90 will once again be de-energized.

Rather than having to apply a pushing force 100 to compress the flexible enclosure 70-1 to energize the light source 90 in the manner described while referring to FIG. 12B, it may be desirable to control the energization of light source 90 by means a simple 2-position switch. Referring in this case to FIGS. 12C and 12D, an electrical conductor (e.g., a wire) 102 is shown projecting downwardly from the light source 90 through the enclosure 70-1 so as to make electrical contact with the battery 95. A switch 104 having on and off switch positions is slidable along a switch plate 106 that is mounted so as to be manually accessible on the exterior of the face 93 of enclosure 70-1. The switch 104 is connected between the battery 95 and the light source 90 by a thin wire or conductive strip 107. The switch 104 is normally in its off position with respect to the switch plate 106 during which time the light source 90 is de-energized. When it is desirable to energize the light source 90, the switch 104 is pushed along the switch plate 106 (in the direction of the reference arrow 108 of FIG. 12D) to its on position to thereby complete an electrical circuit between the battery 95 and the light source 90 by way of the conductor 102. Unlike the light source of FIGS. 12A and 12B, the light source 90 of FIGS. 12C and 12D need not be positioned directly above the battery 95.

The folding glasses 50 shown in FIGS. 7-11 of the drawings have been described as having magnifying lenses 53 and 55 which are preferably manufactured from plastic. However, it is within the scope of this embodiment for the lenses of folding glasses 50 to be manufactured from other materials (e.g., glass) and be of the kind typically used for reading in the same manner as earlier described while referring to FIGS. 1-6.

1. A combination comprising:
an enclosure; and
folding glasses including first and second lenses interconnected with one another such that the first lens is rotated relative to the second lens to a folded configuration of said folding glasses so as to lie in opposite facing alignment with the second lens, said second lens being interconnected with said enclosure such that said first and second lenses in said folded configuration are rotated from being outside said enclosure to being inside said enclosure to be transported therewithin.

2. The combination recited in claim 1, wherein the first and second lenses of said folding glasses are magnifying lenses.

3. The combination recited in claim 1, wherein the first and second lenses of said folding glasses are surrounded by respective first and second rims, said first and second rims being pivotally attached to one another, whereby said first and second lenses are interconnected and rotatable relative to one another to the folded configuration of said folding glasses.

4. The combination recited in claim 3, wherein each of said first and second rims has a coupling tab projecting towards each other and lying one above the other, said coupling tabs being pivotally connected together to pivotally attach said first and second rims to one another.

5. The combination recited in claim 4, further comprising a coupling pin for pivotally connecting the coupling tabs of said first and second rims together.

6. The combination recited in claim 3, wherein the second rim surrounding the second lens of said folding glasses has a coupling tab projecting therefrom, said coupling tab being pivotally attached to said enclosure, whereby said second lens is interconnected with said enclosure to enable said first and second lenses in the folded configuration of said folding glasses to rotate from being outside said enclosure to being inside said enclosure.

7. The combination recited in claim 6, further comprising a coupling pin for pivotally connecting the coupling tab projecting from said second rim to said enclosure.

8. The combination recited in claim 1, further comprising a light source mounted on said enclosure and a battery carried by said enclosure to provide power to said light source.

9. The combination recited in claim 8, wherein there is a gap separating said light source from said battery such that said battery is disconnected from said light source, said enclosure being responsive to a force applied thereto to cause said gap to be eliminated and said battery and said light source to be moved into electrical contact with one another such that said light source is powered by said battery.

10. The combination recited in claim 9, wherein said enclosure is manufactured from a flexible material and said force applied to said flexible enclosure is a pushing force to compress said enclosure and thereby cause said light source and said battery to move into electrical contact with one another such that said light source is powered by said battery.

11. The combination recited in claim 8, further comprising an electrical switch carried by said enclosure and electrically connected between said light source and said battery, said switch having an off position at which said battery is disconnected from said light source and an on position at which said battery is electrically connected to said light source.

12. The combination recited in claim 1, further comprising a ring attached to and carried by said enclosure.

13. A combination comprising:
an enclosure;
folding glasses having first and second lenses pivotally coupled to one another such that said first lens is rotated relative to said second lens to a folded glasses configuration so as to lie in opposite facing alignment with said first lens, said second lens being pivotally coupled to said enclosure such that said first and second lenses in said folded glasses configuration are rotated from being outside said enclosure to being within said enclosure to be transported therewithin;
a light source mounted on said enclosure; and
a battery carried by said enclosure to be electrically connected to said light source to provide power thereto.
